(19) United States
(12) Patent Application Publication
(10) Pub. No.: US 2010/0074656 A1
(43) Pub. Date: Mar. 25, 2010

(54) Flocked Toner Supply Brush

(76) Inventor: Gary Allen Denton, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/236,777

(22) Filed: Sep. 24, 2008

(51) Int. Cl. G03G 15/08

(52) U.S. Cl. 399/281

(57) ABSTRACT

A seamless conductive toner supply brush may comprise conductive fibers flocked onto a metal shaft or rigid conductive core. The shaft/core may be coated with a conductive adhesive and then flocked with fibers about 2-5 mm in length. The brush may be useful as a toner supply brush for supplying toner to a developer member in electrophotographic devices.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

This disclosure relates to a supply member suitable for use in electrophotographic apparatus for supplying toner to a developer member, and more particularly, to a toner supply brush including conductive fibers.

2. Description of Related Art

In electrophotographic apparatus, such as copiers, laser printers, facsimile machines and the like, a toner feeding member may supply toner from a reservoir towards a toner supply roll. The toner supply roll may then rotate and convey the toner to form a thin layer on the surface of a developer member. The developer member may then interact with a photosensitive drum such that an image is formed thereon. The image may then be transferred to and fixed on the surface of media, such as paper.

A toner supply roll, also referred to as a toner adder roll, may typically be an elastic roll adapted to supply the toner to the developing member, which then transfers the toner to the image-bearing medium. The toner supply roll should be capable both of supplying a suitably controlled amount of the toner to the developing member, and scrubbing off unused toner from the developing member, so that the toner may be uniformly distributed on the developing member. The toner supply roll and developer member may have the same rotational direction with respect to one another and may typically form a nip at the contact area between the toner roll and the developing member. Hence, the toner roll and developing member may be moving in opposite directions at the nip in order to effect the scrubbing and toner-supply functions.

Typically, toner supply rolls are formed of flexible polymeric foams. However, such foams exhibit inherently low electrical conductivity, and, therefore, resistivity and static discharge must be controlled via conductive agents incorporated in the roll.

Toner supply rolls may comprise a metal core or shaft covered with a layer of foam which may interact with the developer member. However, such foam surfaces have been found to generate a considerable amount of torque and heat as they scrub against the developer member surface.

Toner supply rolls in the form of brushes may be produced by weaving a conductive pile fabric and wrapping the woven pile fabric around a shaft or core. This construction method has two significant problems: 1) the brush density is typically lower at the boundaries of the wrapped fabric where a seam may be formed, and 2) the weaving process is labor intensive which results in cost issues for the woven pile fabrics.

It has been found that a toner supply brush may be provided, including flocked conductive fibers, that is seamless, has relatively higher conductivity and operates with less torque and heat build-up, which may be desirable for monocomponent toner cartridges and developer units.

### SUMMARY

A seamless conductive toner supply brush may comprise conductive fibers disposed on a metal shaft or rigid conductive core. The shaft/core may be coated with a conductive adhesive and then flocked with fibers about 2-5 mm in length. Conductive filament material produced by suffusing carbon black particles into the surface of nylon monofilament material has been shown to possess desirable mechanical and electrical properties for toner supply brushes. The resulting fibers may be 2-3 orders of magnitude more conductive than nylon fibers that are extruded with carbon black dispersed throughout their volume. These fibers may also be resistant to changes in humidity, may retain flexibility and may show excellent tribocharging performance with known toners.

In one aspect a toner supply brush is described, the toner supply brush comprising a conductive core, an adhesive layer overlying the outer surface of the core, and a plurality of fibers attached to the core by the adhesive layer wherein the fibers exhibit an electrical resistance of less than 10⁶ ohms/cm.

In another aspect a toner supply brush is described, the toner supply brush comprising a conductive cylindrical core, and a plurality of conductive fibers disposed substantially normal to the surface of the core wherein the fibers are greater than or equal to 2.0 mm in length.

In another aspect a method of making a toner supply brush is provide the method including the steps of spraying a plurality of conductive polymer fibers onto a cylindrical core, and adhering the polymer fibers to the core in an orientation wherein the fibers are substantially normal to surface of the core.

### BRIEF DESCRIPTION OF THE DRAWINGS

The details of this invention will be described in connection with the accompanying drawing, in which

FIG. 1 is a cross-sectional view of an image forming unit and associated power supply;

FIG. 2 is a cross-sectional view of an embodiment of a toner supply brush, according to the present disclosure; and

FIG. 3 is a cross-section view of the toner supply brush embodiment of FIG. 2 as viewed along the axis of the brush.

### DETAILED DESCRIPTION

As printer speeds have increased, numerous problems have been observed associated with mechanical working of the toner particles by the toner cartridge components. Conventional foam toner supply rolls may generate a considerable amount of torque and heat as they scrub against the developer member surface. A flocked toner supply brush has been found to substantially reduce both torque and heat issues without producing image artifacts associated with woven fabric boundaries.

In one aspect, a toner supply brush may include a plurality of fibers that are electrically conductive. In some embodiments the fibers may exhibit resistivity between 10³ to 10⁸ ohms/cm or from 10³ to 10⁶ ohms/cm. Other embodiments may exhibit resistivities of less than 10⁶ ohms/cm, less than 10⁵ ohms/cm or less than 10⁴ ohms/cm. In one set of embodiments, the fibers may have an “uneven electrical cross-section,” meaning that the fibers exhibit different levels of conductivity across different portions of the fiber's cross-section. For instance, the fibers may exhibit high conductivity at the periphery while exhibiting low conductivity in the axial core. These fibers may be made by suffusing carbon particles into the periphery of non-conductive polymer fibers. Fibers having uneven electrical cross-sections can provide improved conductivity compared to those having even electrical cross-sections and can retain the flexibility of the pure polymer fibers.

In another aspect, a toner supply brush may include a plurality of conductive polymer fibers having a length of greater than about 1 mm in length. These fibers have sufficient length and are pliable enough to provide a flexible diameter to the brush. This flexible diameter brush can provide an even transfer of toner while not necessitating the exacting tolerances between adjacent components that are typically required by toner supply brushes that do not have fibers greater than 1.0 mm in length. For example, a single toner supply brush having fibers of 3 mm in length can have an effective diameter that varies by 1, 2, 3 or 4 mm depending how tight the dimensions are between the toner supply brush and any adjoining components.

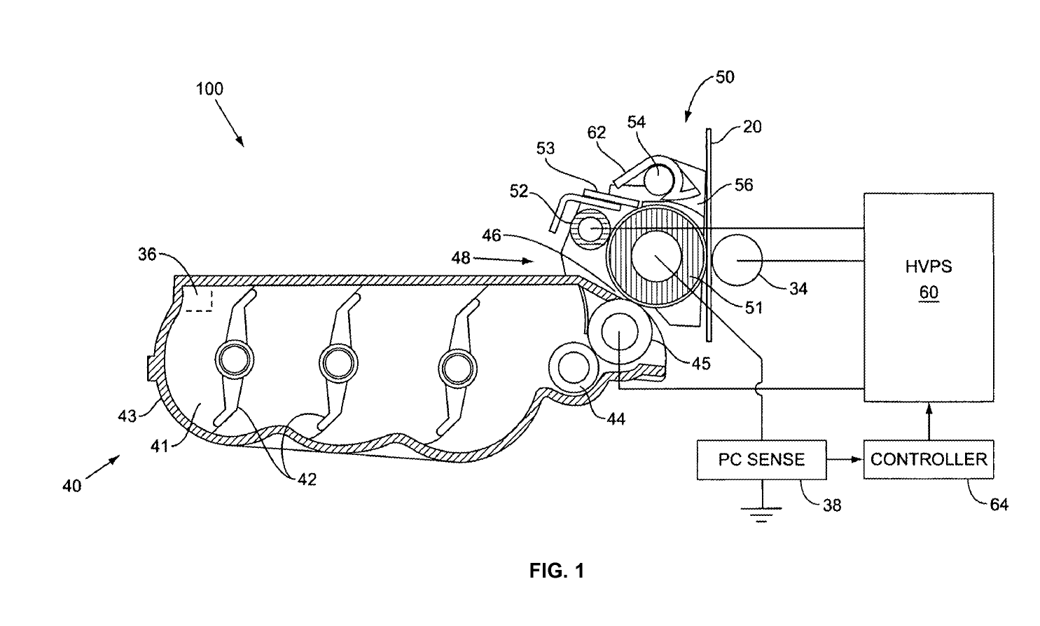

FIG. 1 illustrates a cross-sectional view of an image forming unit 100 in an operating orientation. The developer unit 40 may comprise an exterior housing 43 that may form a reservoir 41 for holding a supply of undeveloped toner. One or more agitating members 42 may be positioned within the reservoir 41 for agitating and moving the toner towards a toner supply brush 44 and the developer member 45. Toner may be moved from the reservoir 41 via the one or more agitating members 42, to the toner supply brush 44, and finally to the developer member 45. The developer unit 40 may be structured with the developer member 45 on an exterior section where it may be accessible for contact with a photoconductive member 51 at a nip 46.

The photoconductive (PC) unit 50 may comprise a photoconductive member 51 and a charge roller 52. The photoconductive member 51 may be an aluminum hollow-core drum coated with one or more layers of light-sensitive organic photoconductive materials. A housing 56 may form the exterior of a portion of the photoconductor unit 50. The photoconductive member 51 may be mounted protruding from the PC unit 50 to contact the developer member 45 at nip 46. Charge roller 52 may be electrified to a predetermined bias by a high voltage power supply (HVPS) 60. The charge roller 52 may apply an electrical charge to the surface of the photoconductive member 51. During image creation, selected portions of the surface of the photoconductive member 51 may be exposed to optical energy, such as laser light, through aperture 48. Exposing areas of the photoconductive surface 51 in this manner may create a discharged latent image on the photoconductive member 51. That is, the latent image may be discharged to a lower charge level than areas of the photoconductive member 51 that are not illuminated.

The developer member 45 and the toner thereon may be charged to another bias level by the HVPS 60 that is advantageously set between the bias level of charge roller 52 and the discharged latent image. This charged toner may be carried by the developer member 45 to the latent image formed on the surface of the photoconductive member 51. As a result of the imposed bias differences, the toner may be attracted to the latent image and repelled from the remaining, higher charged portions of the photoconductive surface. At this point in the image creation process, the latent image is said to be developed.

The developed image may subsequently be transferred to a media sheet being carried past the photoconductive member 51 by media transport belt 20. A transfer roller 34 may be disposed behind the transport belt 20 in a position to impart a contact pressure at the transfer nip. In addition, the transfer roller 34 may be advantageously charged, typically to a polarity that is opposite the charged toner and charged photoconductive member 51 to promote the transfer of the developed image to the media sheet. The polarity of the transfer roller 34 may also be switched periodically, typically between print jobs, to clean the transfer roller 34. This change in polarity may induce the transfer of toner back towards the transport belt 20 and/or the photoconductive member 51, each of which has their own associated cleaning device (e.g., cleaner (doctor) blade 53).

The cleaner blade 53 may contact the surface of the photoconductive member 51 to remove toner that may remain on the photoconductive member 51 following transfer of the developed image to a media sheet passing between the photoconductive member 51 and the media transport belt 20. The residual toner may be moved to a cleaner housing 62, where a waste toner auger 54 may move the waste toner out of the photoconductor unit 50 and towards a waste toner container (not shown), which may be disposed of once full.

A controller 64 may include control circuitry that is operable to direct the transmission of a signal originating from the HVPS 60 that may propagate through the components and may be sensed by the PC Sense circuit 38 and controller 64 as an indication of the presence or absence of the PC unit 50. The controller 64 may be the same controller that controls the application of charge biases to the charge roller 52, developer member 45, and transfer roller 34 via the HVPS 60 during normal image forming operation.

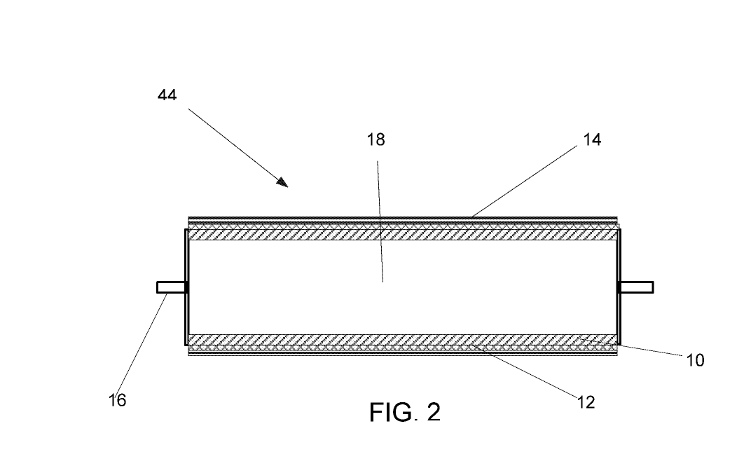

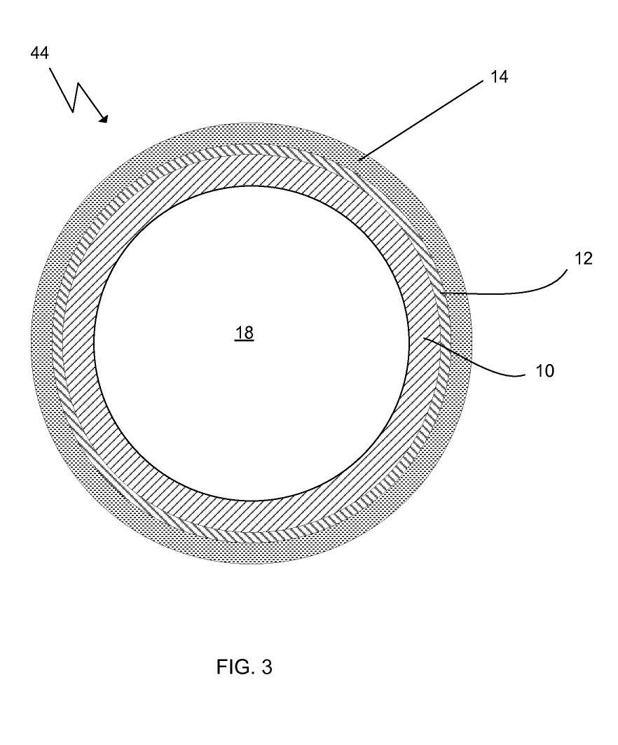

FIGS. 2 and 3 are cross-sectional views of an embodiment of the toner supply brush 44 of FIG. 1. The brush may comprise a rigid conductive core 10, which has been coated with a conductive or non-conductive adhesive 12 and flocked fibers 14. The brush may also include shaft ends 16 journaled to the brush 44, for attachment to and location in the housing 43.

In the case of a smaller diameter supply brush, for instance, about 7 mm in diameter, the core portion 10 may be solid, while for larger diameter brushes, for instance, about 11 mm in diameter and greater, a core including a hollow portion 18, as shown in FIGS. 2 and 3, may be used to reduce the mass of the brush 44.

Preferred flocked fibers 14 may comprise polymeric fibers about 1-10 mm in length, including all intervals and increments therebetween. In particular, fibers 2-5 mm in length may be used. Each of the individual fibers used to flock a brush may be of substantially the same length and substantially the same diameter. Flock density may be, in part, a function of the fiber denier. For example, a smaller denier fiber may allow for a greater flock density. Fibers may be randomly flocked across the surface or may be flocked in a pattern. For instance, increased fiber density may be achieved by packing the fibers together in a hexagonal grid pattern. Fibers may be disposed on the surface of a core at a density of, for example, greater than 100, greater than 500, greater than 1000, greater than 10,000, greater than 25,000 or greater than or equal to 50,000 fibers per square centimeter. Flock density may also be determined by calculating the percentage of the surface that is covered by fibers. For instance, measured as a percentage of the surface covered by fibers, flock density may be greater than 25%, greater than 50%, greater than 65%, greater than 75%, greater than 80% or greater than 90%. Fiber diameters may be chosen to provide sufficient flexibility for a chosen fiber length. For example, a flexible fiber can be chosen to allow for adequate contact with a developer roll 45 where either large or small gaps may exist between the brush 44 and the developer roll 45. When the gap is large, the fibers will be substantially straight at the nip between the brush 44 and the developer roll 45. When the gap is small, the fibers will bend providing a brush of functionally decreased diameter. In this case the brush 44 may be able to transfer toner to developer roll 45 without the excessive friction and heat formation that can occur with foam covered rolls. In some embodiments, fiber diameters of 10-100 μm may be used. In particular, fiber diameters of about 25 μm-75 μm (for instance, about 5-20 denier) or about 25 μm-50 μm have been found to be useful. In one embodiment, a conductive nylon fiber of 15.5 denier was found to achieve good packing density. The fibers may comprise any polymeric material capable of being made conductive. In one set of embodiments, non-conductive fibers may be made conductive by suffusing a conductive substance into the fibers.

Suffusion refers to a process wherein a polymeric fiber or filament may be coated with a solution of a conductive material, such as carbon black, dispersed in a solvent in which the conductive material is stable. The carbon black may have a particle size of about 10-100 nm and all values and increments therein. For example, in some cases the carbon black may have a particle size of 20-40 nm. The particles may be of consistent or variable size. The solvent may comprise a material which is pervious to the fiber being coated. That is, the solvent may be absorbed to some degree by the fibers and may cause the fibers to swell. Once the solvent has penetrated the fibers to the desired degree, it may be removed, for instance by evaporation, leaving the carbon black particles absorbed into the outer surface of the fibers. This conductive particle layer may be, for instance, about 1 μm in thickness. In other words, the conductive particles may be disposed into the fibers to the level of penetration of the solvent, and thus be more concentrated towards the outer surface of the fiber with little or no particles disposed near the center of the fiber. This can result in a fiber having an uneven electrical cross-section wherein the periphery of the fiber is conductive while the core of the fiber is of high electrical resistance. The difference in resistivity between the outer surface and the core of a fiber may be, for example, greater than one order of magnitude, greater than two orders of magnitude, greater than five orders of magnitude, greater than eight orders of magnitude or greater than ten orders of magnitude.

In particular, a conductive filament material manufactured by Shakespeare Company LLC, called Resistat™, has been shown to possess desirable mechanical and electrical properties for toner supply brushes. Resistat™ filaments may be produced by suffusing carbon black particles into the surface of nylon monofilament material. The resulting fibers are 2-3 orders of magnitude more conductive than nylon fibers that are extruded with carbon black throughout their volume. These fibers are also relatively insensitive to changes in humidity and show excellent tribocharging performance with known toners.

The conductive fibers may be reduced to the desired length and deposited on a rigid core or shaft by flocculation. The shaft or core may be coated with an adhesive that may be conductive. In this process, the fibers may typically be electrostatically charged and then sprayed onto the target surface in the presence of an electric field. The electric field may serve two purposes—to direct the fibers to the target surface and to align the fibers so that they disposed approximately perpendicular to the receiving surface. A thin layer of liquid adhesive on the receiving surface acts to bind the fibers to the surface. The adhesive may be electrically conductive. It has been found that conductive fibers can also be flocked onto a rigid core. The fibers can be charged and electrostatically flocked using an electric field to provide the orientation force. It may be preferred that individual fibers are fixed to the core so that the longitudinal axis of each fiber is substantially normal to the surface of the core. It is to be understood however that all fibers need not be perfectly normal to the surface of the core and that the flocking process may result in a large number of fibers that are at different angles to the core surface.

In another embodiment, non-conductive polymeric fibers may be flocked onto a rigid core and may be rendered conductive after attachment to the core. For example, carbon black particles may be suffused into attached nylon fibers after flocculation using the methods described herein.

Toner supply brushes that include a fabric that is wrapped and secured around a core include a seam section that can provide inconsistent distribution and/or retention of toner. A flocked toner supply brush, however, may include fibers at a consistent density around the circumference of the brush. This consistent density means that the roll is seamless and includes no regions that can result in this inconsistent distribution of particles.

It is believed that when flocked surfaces are used in printing applications that loose fibers may be shed from the brush during operation and that these loose fibers may destroy the quality of the image. An experiment was run to assess the cartridge sensitivity to loose fibers from the toner supply brush described above. In this experiment approximately 100 loose fibers were seeded into the working sump of a prototype toner cartridge similar to the cartridge used in a Lexmark model C782 printer. Print quality was then monitored for 2000 pages looking for image defects such as streaks which might occur if a loose fiber lodged in the doctor blade nip and impeded the flow of toner under the blade. No image defects were observed. This result suggests that, contrary to previous beliefs, flocked toner supply brushes may be usable in toner cartridges with doctor blades such as checkmark doctor blades.

The foregoing description of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A toner supply brush comprising:
a conductive core;
an adhesive layer overlying the outer surface of the core; and
a plurality of fibers attached to the core by the adhesive layer wherein the fibers exhibit an electrical resistance of less than 10⁶ ohms/cm.

2. The toner supply brush of claim 1 wherein the fibers are comprised of polyamide.

3. The toner supply brush of claim 1 wherein the length of the fibers is greater than 1 mm.

4. The toner supply brush of claim 1 wherein the length of the fibers is between 2 and 5 mm.

5. The toner supply brush of claim 1 wherein the fibers are suffused with carbon particles.

6. The toner supply brush of claim 1 wherein the brush is void of a foam layer.

7. The toner supply brush of claim 1 wherein the fibers have an electrical resistance between 10³ to 10⁶ ohms/cm.

8. The toner supply brush of claim 1 wherein the fibers have an electrical resistance of less than 10⁵ ohms/cm.

9. The toner supply brush of claim 1 wherein the fibers exhibit an uneven electrical cross-section.

10. An electrophotographic device comprising the toner supply brush of claim 1.

11. A toner supply brush comprising:
a conductive cylindrical core; and
a plurality of conductive fibers disposed substantially normally to the surface of the core wherein the fibers are greater than or equal to 2.0 mm in length.

12. The toner supply brush of claim 11 wherein the fibers are comprised of polyamide.

13. The toner supply brush of claim 11 wherein the fibers have a nominal diameter of between 0.025 and 0.05 mm.

14. The toner supply brush of claim 11 wherein the length of the fibers is between 2 and 5 mm.

15. The toner supply brush of claim 11 wherein the fibers are suffused with carbon particles.

16. The toner supply brush of claim 11 wherein the fibers are disposed on the core at a density of greater than 100 fibers per square centimeter.

17. The toner supply brush of claim 11 wherein the fibers are disposed on the core at a density of greater than 1000 fibers per square centimeter.

18. The toner supply brush of claim 11 wherein the fibers have an electrical resistance between 10³ to 10⁶ ohms/cm.

19. A method of making a toner supply brush comprising:
spraying a plurality of conductive polymer fibers onto a cylindrical core; and
adhering the polymer fibers to the core in an orientation wherein the fibers are substantially normal to surface of the core.

20. The method of claim 19 wherein the fibers are greater than or equal to about 1.0 mm in length.

21. The method of claim 19 wherein the fibers have an unequal electrical cross-section.

22. The method of claim 19 wherein the polymer fibers are extruded from a non-conductive polymer and subsequently suffused with conductive particles to produce a conductive polymer fiber.

23. The method of claim 19 wherein the fibers exhibit a resistivity of less than 10⁶ ohms/cm.
